(19) United States
(12) Patent Application Publication
(10) Pub. No.: US 2010/0079448 A1
(43) Pub. Date: Apr. 1, 2010

(54) 3D Depth Generation by Block-based Texel Density Analysis

(76) Inventors: Liang-Gee Chen, Taipei (TW); Chao-Chung Cheng, Taipei (TW); Chung-Te Li, Taipei (TW); Ling-Hsiu Huang, Tainan (TW)

Correspondence Address: STOUT, UXA, BUYAN & MULLINS LLP, 4 VENTURE, SUITE 300, IRVINE, CA, 92618, US

(21) Appl. No.: 12/242,592

(22) Filed: Sep. 30, 2008

(51) Int. Cl. G06T 15/00; G09G 5/00

(52) U.S. Cl. 345/419; 345/582; 382/173

(57) ABSTRACT

A system and method of generating three-dimensional (3D) depth information is disclosed. A classification and segmentation unit segments a two-dimensional (2D) image into a number of segments, such that pixels having similar characteristics are classified into the same segment. A spatial-domain texel density analysis unit performs texel density analysis on the 2D image to obtain textual density. A depth assignment unit assigns depth information to the 2D image according to the analyzed textual density.

### BACKGROUND OF THE INVENTION

1. Field of the Invention

The present invention generally relates to three-dimensional (3D) depth generation, and more particularly to 3D depth generation by block-based texel density analysis.

2. Description of the Prior Art

When three-dimensional (3D) objects are mapped onto a two-dimensional (2D) image plane by prospective projection, such as an image taken by a still camera or video captured by a video camera, a lot of information, such as the 3D depth information, disappears because of this non-unique many-to-one transformation. That is, an image point cannot uniquely determine its depth. Recapture or generation of the 3D depth information is thus a challenging task that is crucial in recovering a full, or at least an approximate, 3D representation, which may be used in image enhancement, image restoration or image synthesis, and ultimately in image display.

Texture is a property used to describe or represent the surface of an object, and consists of texture primitives or texture elements (“texels”). The texture measure can be used to discriminate between a finely and a coarsely textured object, and is conventionally used to generate 3D depth information. Regarding the notion of texture gradient, or greatest rate of magnitude change, an object has denser texture as it goes further away from the viewer. Specifically, 2D frequency transform is performed on the original 2D image and its enlarged/reduced images. The texture gradient of the original 2D image can be obtained according to the texture density of the enlarged/reduced images, and 3D depth information is assigned along the texture gradient. The 2D frequency transform requires a complex calculation and consumes precious time, causing real-time analysis to video processing impossible or extremely difficult.

For reasons including the fact that conventional methods could not generate 3D depth information in real time, a need has arisen to propose a system and method of 3D depth generation that can recapture or generate 3D depth information to quickly recover or approximate a full 3D representation.

### SUMMARY OF THE INVENTION

In view of the foregoing, it is an object of the present invention to provide a novel system and method of 3D depth information generation for rapidly recovering or approximating a full 3D representation.

According to one embodiment, the present invention provides a system and method of generating three-dimensional (3D) depth information. A classification and segmentation unit segments a two-dimensional (2D) image into a number of segments, such that pixels having similar characteristics are classified into the same segment. A spatial-domain texel density analysis unit performs texel density analysis on the 2D image to obtain textual density. In one embodiment, the spatial-domain texel density analysis unit is block-based in which the 2D image is divided into a number of blocks, and the blocks are analyzed in sequence to determine a quantity of edges included therein. A depth assignment unit assigns depth information to the 2D image according to the analyzed textual density, therefore recovering or approximating a full 3D representation in real time.

### BRIEF DESCRIPTION OF THE DRAWINGS

FIG. 1 illustrates a block diagram of a 3D depth information generation system according to one embodiment of the present invention; and

FIG. 2 illustrates an associated flow diagram demonstrating the steps of a 3D depth information generation method according to the embodiment of the present invention.

### DETAILED DESCRIPTION OF THE INVENTION

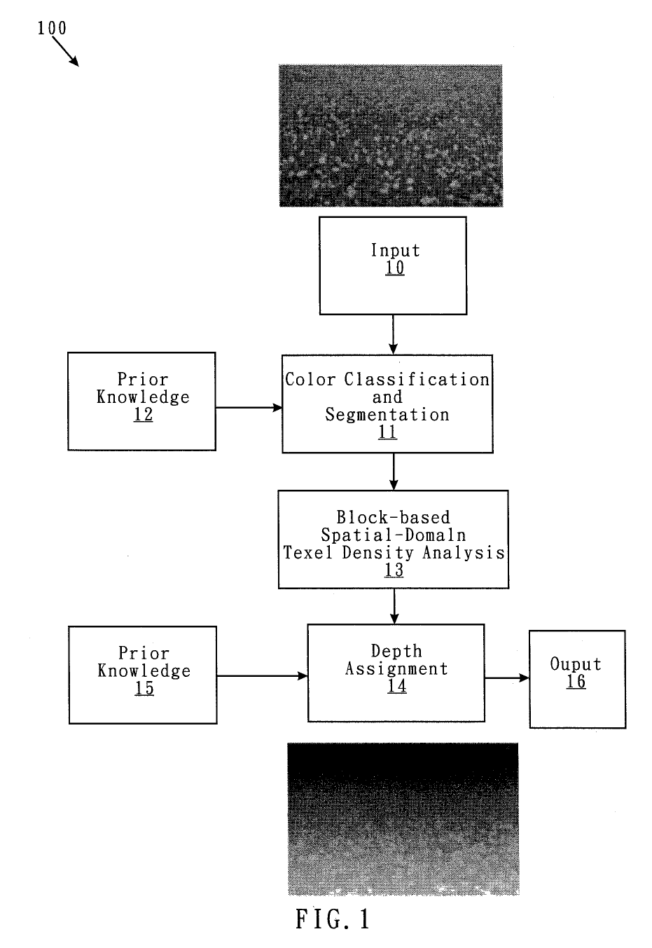

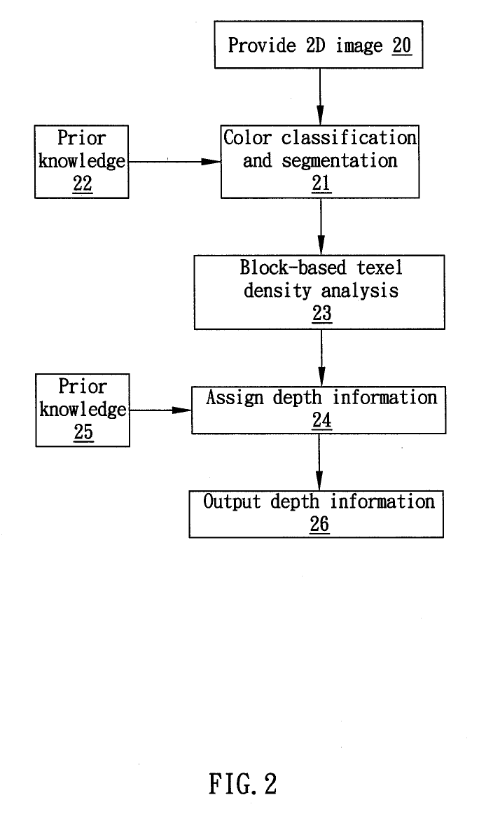

FIG. 1 illustrates a block diagram of a three-dimensional (3D) depth information generation system 100 according to one embodiment of the present invention. Exemplary images, including an original image and a resultant image, are also shown for better comprehension of the embodiment. FIG. 2 illustrates an associated flow diagram demonstrating steps of the 3D depth information generation method according to the embodiment of the present invention.

With reference to these two figures, an input device 10 provides or receives one or more two-dimensional (2D) input image(s) to be image/video processed according to the embodiment of the present invention (step 20). The input device 10 may in general be an electro-optical device that maps 3D object(s) onto a 2D image plane by prospective projection. In one embodiment, the input device 10 may be a still camera that takes the 2D image, or a video camera that captures a number of image frames. The input device 10, in another embodiment, may be a pre-processing device that performs one or more of digital image processing tasks, such as image enhancement, image restoration, image analysis, image compression and image synthesis. Moreover, the input device 10 may further include a storage device, such as a semiconductor memory or hard disk drive, which stores the processed image from the pre-processing device. As discussed above, a lot of information, particularly the 3D depth information, is lost when the 3D objects are mapped onto the 2D image plane, and therefore, according to an aspect of the invention, the 2D image provided by the input device 10 is subjected to image/video processing through other blocks of the 3D depth information generation system 100, which will be discussed below.

The 2D image is processed by a color classification and segmentation unit 11 that segments the entire image into a number of segments (step 21), such that the pixels that have similar characteristics, such as color or intensity, are classified into the same segment. In this specification, the term “unit” is used to denote a circuit, software, such as a part of a program, or their combination. In one embodiment, the color classification and segmentation unit 11 segments the image according to color. That is, pixels of the same or similar color are classified in the same block. Prior knowledge 12 may be optionally provided to the color classification and segmentation unit 11 (step 22), assisting in the color classification. Generally speaking, the prior knowledge 12 provides specific color according to respective theme, for example flowers, grass, people or tile, in the texture. For example, the (yellow) flowers and the (green) grass are two main themes in the image associated with the input device 10. The prior knowledge 12 may be generated from a preprocessing unit (not shown), or, alternatively, may be provided by a user. Accordingly, the color classification and segmentation unit 11 primarily segments the image into two blocks, namely, the flowers and the grass.

Subsequently, a block-based spatial-domain texel (or textual) density analysis unit 13 performs texel density analysis on each block respectively to obtain textual density (step 23). In the illustrated embodiment, the 2D image can consist, for example, of 512×512 pixels, in which case the entire image is then divided into 64×64 blocks, each having 8×8 pixels. As the analysis in the embodiment is performed in spatial domain and blocks are analyzed in sequence, real-time video processing thus becomes practicable or possible. Specifically, each block is analyzed to determine the quantity of edges included in each block. For example, the block located within the grass that is far from the viewer has more edges than the block located within the flower that is close to the viewer. In other words, equivalently speaking, the block within the grass has higher texel (or textual) density than the block within the flowers, indicating that the grass is further away from the viewer. While the determination of the quantity of edges in each block is executed in the embodiment, other spatial-domain texel density analysis can be used in addition or instead.

Afterwards, a depth assignment unit 14 assigns depth information to the blocks (step 24) according to prior knowledge 15 (step 25). In the exemplary embodiment, the blocks (i.e., the flowers) having smaller texel density are assigned depth value smaller than the blocks (i.e., the grass) having greater texel density. For the shown exemplary image, the prior knowledge 15 provides the low-density blocks (i.e., the flowers) a smaller depth level (that is, closer to the viewer) than the high-density blocks (i.e., the grass), or, in another embodiment, provides a bottom segment with a smaller depth level than a top segment. Similarly to the prior knowledge 12, the prior knowledge 15 may be generated from a preprocessing unit (not shown), and/or may be provided by a user.

In addition to the depth level, the prior knowledge 15 may also provide respective depth range to the blocks. Generally speaking, the prior knowledge 15 provides a larger depth range to a block that is closer to the viewer than a block that is further away from the viewer. For the shown exemplary image, the prior knowledge 15 provides a larger depth range to the (closer) flowers, and, accordingly, the flowers possess greater depth variation than the grass.

An output device 16 receives the 3D depth information from the depth assignment unit 14 and provides the resulting or output image (step 26). The output device 16, in one embodiment, may be a display device for presentation or viewing of the received depth information. The output device 16, in another embodiment, may be a storage device, such as a semiconductor memory or hard disk drive, which stores the received depth information. Moreover, the output device 16 may further, or alternatively, include a post-processing device that performs one or more of digital image processing tasks, such as image enhancement, image restoration, image analysis, image compression and image synthesis.

According to the embodiments of the present invention discussed above, the present invention can recapture or generate 3D depth information to quickly recover or approximate a full 3D representation in real time compared to conventional 3D depth information generation methods as described in the prior art section in this specification.

Although specific embodiments have been illustrated and described, it will be appreciated by those skilled in the art that various modifications may be made without departing from the scope of the present invention, which is intended to be limited solely by the appended claims.

What is claimed is:

1. A system of generating three-dimensional (3D) depth information, comprising:
a classification and segmentation unit that segments a two-dimensional (2D) image into a plurality of segments, such that pixels having similar characteristics are classified into the same segment;
a spatial-domain texel density analysis unit that performs texel density analysis on the 2D image to obtain textual density; and
a depth assignment unit that assigns depth information to the 2D image according to the analyzed textual density.

2. The system of claim 1, wherein the 2D image is segmented and classified according to color.

3. The system of claim 1, wherein the 2D image is segmented and classified according to intensity.

4. The system of claim 1, further comprising stored or inputted prior knowledge that provides specific color or intensity to the classification and segmentation unit.

5. The system of claim 1, wherein:
the spatial-domain texel density analysis unit is block-based, and
the 2D image is divided into a plurality of blocks for facilitation of sequential analysis of texel densities.

6. The system of claim 5, wherein each of the blocks is analyzed to determine quantity of edges included therein.

7. The system of claim 1, further comprising prior knowledge that provides low-density blocks with a smaller depth level than high-density blocks.

8. The system of claim 1, further comprising prior knowledge that provides a bottom segment with a smaller depth level than a top segment.

9. The system of claim 1, further comprising an input device that maps 3D objects onto a 2D image plane.

10. The system of claim 9, wherein the input device further stores the 2D image.

11. The system of claim 1, further comprising an output device that receives the 3D depth information.

12. The system of claim 11, wherein the output device performs one or more of storing and displaying the 3D depth information.

13. A method of using a device to generate three-dimensional (3D) depth information, comprising:
segmenting a two-dimensional (2D) image into a plurality of segments, such that pixels having similar characteristics are classified into the same segment;
performing texel density analysis on the 2D image to obtain textual density; and
assigning depth information to the 2D image according to the analyzed textual density.

14. The method of claim 13, wherein the 2D image is segmented and classified according to color.

15. The method of claim 13, wherein the 2D image is segmented and classified according to intensity.

16. The method of claim 13, further comprising receiving prior knowledge, which provides specific color or intensity, in the segmenting step.

17. The method of claim 13, the texel density analysis being block-based, and the 2D image being divided into a plurality of blocks having texel densities that are analyzed in sequence.

18. The method of claim 17, wherein each of the blocks is analyzed to determine a quantity of edges included therein.

19. The method of claim 13, further comprising receiving prior knowledge that provides low-density blocks with a smaller depth level than high-density blocks in the assigning of depth information step.

20. The method of claim 13, further comprising receiving prior knowledge that provides a bottom segment with a smaller depth level than a top segment in the assigning of depth information step.

21. The method of claim 13, further comprising a step of mapping 3D objects onto a 2D image plane.

22. The method of claim 21, further comprising a step of storing the 2D image.

23. The method of claim 13, further comprising a step of receiving the 3D depth information.

24. The method of claim 23, further comprising a step of storing or displaying the 3D depth information.
